(19) United States
(12) Patent Application Publication
(10) Pub. No.: US 2011/0297619 A1
(43) Pub. Date: Dec. 8, 2011

(54) HYDROCARBON ABSORBING APPARATUSES AND METHODS OF PREPARING AND USING THE SAME

(76) Inventor: Stephen C. Kurtzman, Crestline, OH (US)

(21) Appl. No.: 13/156,322

(22) Filed: Jun. 8, 2011

Related U.S. Application Data
(60) Provisional application No. 61/352,813, filed on Jun. 8, 2010.

(51) Int. Cl. E02B 15/10; C02F 1/28; C02F 101/32

(52) U.S. Cl. 210/693; 210/242.4

(57) ABSTRACT

The present embodiments disclose apparatuses and methods for extracting oil and other hydrocarbons from bodies of water (and, in some embodiments, from solid ground), using, for example, polyester (typically polyethylene terephthalate fibers coated in latex) and/or nylon tire reinforcement cords contained within water-permeable containment devices.

### CROSS-REFERENCE TO RELATED APPLICATIONS

This application claims priority from U.S. Provisional Patent Application No. 61/352,813, filed Jun. 8, 2010, which is incorporated by reference herein in its entirety.

### BACKGROUND

Serious environmental and safety issues can arise from the spilling, leaking, or other discharge of hydrocarbons into places where the hydrocarbons are unwanted. For example, hydrocarbons too often leak onto the surface of water, the ground, roadways, or the floor in industrial settings. Recovery of such hydrocarbons is not trivial. An efficient way to recover or otherwise collect the hydrocarbons is a long felt need.

A parallel, yet unrelated environmental challenge is how to dispose of the mounting volume of used tires from automobiles. Simply discarding the tires in landfills is not an adequate solution. Generally speaking, the tires are composed of rubber, steel, and reinforcement cord fibers. Some operations are in place to shred and recycle tire components, including rubber and steel, thereby limiting the amount of those components placed into landfills. However, the reinforcement cord fibers separated from the tire during recycling are often still disposed of in landfills. An environmentally responsible way to recycle or reuse reinforcement cord fibers separated from used tires is likewise a long felt need.

### SUMMARY

In one embodiment, a hydrocarbon absorbing apparatus is provided. The hydrocarbon absorbing apparatus includes a containment device. At least a portion of the containment device is comprised of a permeable material. The containment device has a volume to outer surface area ratio of about 0.50 to 3. The apparatus also includes absorbent material enclosed within the containment device. The absorbent material is comprised of polyester fibers and/or nylon fibers that have been shredded such that the apparatus floats when placed onto a surface of water. The absorbent material is present within the containment device in a ratio of between about 0.015 to about 0.12 oz. of the absorbent material per cubic inch of the containment device.

In another embodiment, a hydrocarbon absorbing apparatus is provided. The hydrocarbon absorbing apparatus includes a containment device. At least a portion of the containment device is comprised of a permeable material. The apparatus further includes absorbent material enclosed within the containment device. The absorbent material is reinforcement cord reclaimed from used tires, and is comprised of polyethylene terephthalate fibers and/or nylon fibers that have been shredded such that the apparatus floats when placed onto a surface of water. The absorbent material is present within the containment device in a ratio of between about 0.02 to about 0.11 oz. of the absorbent material per cubic inch of the containment device.

In one embodiment, a method for absorbing hydrocarbons is provided. The method comprises placing absorbent material contained within a water permeable containment device in contact with a surface of a body of water containing hydrocarbons. The absorbent material is reinforcement cord reclaimed from used tires, and is comprised of polyester fibers and/or nylon fibers that have been shredded such that the apparatus floats when placed onto the surface of the body of water. The absorbent material is present within the containment device in a ratio of between about 0.015 to about 0.12 oz. of the absorbent material per cubic inch of the containment device. The containment device has a volume to outer surface area ratio of about 0.75 to about 2.

### BRIEF DESCRIPTION OF THE DRAWINGS

The accompanying figures, which are incorporated in and constitute a part of the specification, illustrate various example apparatuses, systems, methods, results, and so on, and are used merely to illustrate various example embodiments. Various components depicted in the figures may not be drawn to scale, and the various assemblies and designs depicted in the figures are presented for purposes of illustration only, and should not be considered in any way as limiting.

FIG. 1 is a perspective view of one embodiment of a hydrocarbon absorbing apparatus.

FIG. 2 is a cross-sectional view taken generally along line 2-2 of FIG. 1.

FIG. 3 is a perspective view of one embodiment of a hydrocarbon absorbing apparatus, in which the containment device is configured to form a pillow.

FIG. 4 is a perspective view of one embodiment of a hydrocarbon absorbing apparatus, in which the containment device is configured to form a pad.

FIG. 5 is an illustration showing a method for using multiple hydrocarbon absorbing apparatuses of varying shape.

FIG. 6 is an illustration showing one embodiment of the inventive system in use on a solid surface.

FIG. 7 shows example effects on absorbency of varying the amount of absorbent material within a containment device.

FIG. 8 shows example effects on absorption rate of varying the amount of absorbent material within a containment device.

FIG. 9 shows example effects on absorbency of varying the ratio of volume to outer surface area of the containment device portion of the hydrocarbon absorbing apparatus.

FIG. 10 shows example effects on absorption rate of varying the ratio of volume to outer surface area of the containment device portion of the hydrocarbon absorbing apparatus.

FIG. 11 is an illustration showing one embodiment of the inventive system in use, particularly compressing the hydrocarbon absorbing apparatus to extract at least a portion of any absorbed hydrocarbons.

### DETAILED DESCRIPTION

The present embodiments disclose apparatuses and methods for extracting oil and other hydrocarbons from bodies of water (and, in some embodiments, from solid ground), using, for example, polyester (typically polyethylene terephthalate fibers coated in latex) and/or nylon tire reinforcement cords contained within water-permeable containment devices. Latex coated polyethylene terephthalate fibers (d=1.34-1.40 g/cm³) and nylon fibers (d=1.15 g/cm³) are denser than water (1 g/cm³). However, the cords have been shredded into a fluff, changing the physical properties of the cords to an extent that, when the proper ratios of: (1) the amount of absorbent material to the volume of containment device; and (2) the volume of containment device volume to containment device outer surface area, are used, the entire apparatus floats when placed on water, even after the absorbent material has absorbed hydrocarbons in an amount many times the weight of the fluff and the apparatus combined. Further, the apparatuses are able to be reused several times without losing significant efficacy.

The absorbent material does not require addition of caustic acids to form gels or sponges, does not require the addition of glass fibers, and does not require the addition of potentially environmentally harmful polystyrene particles to aid buoyancy.

The results are surprising and meet two long felt, yet unresolved needs: (1) an efficient and easily constructed hydrocarbon clean-up apparatus; and (2) an environmentally acceptable solution for the problem of mounting tire scrap.

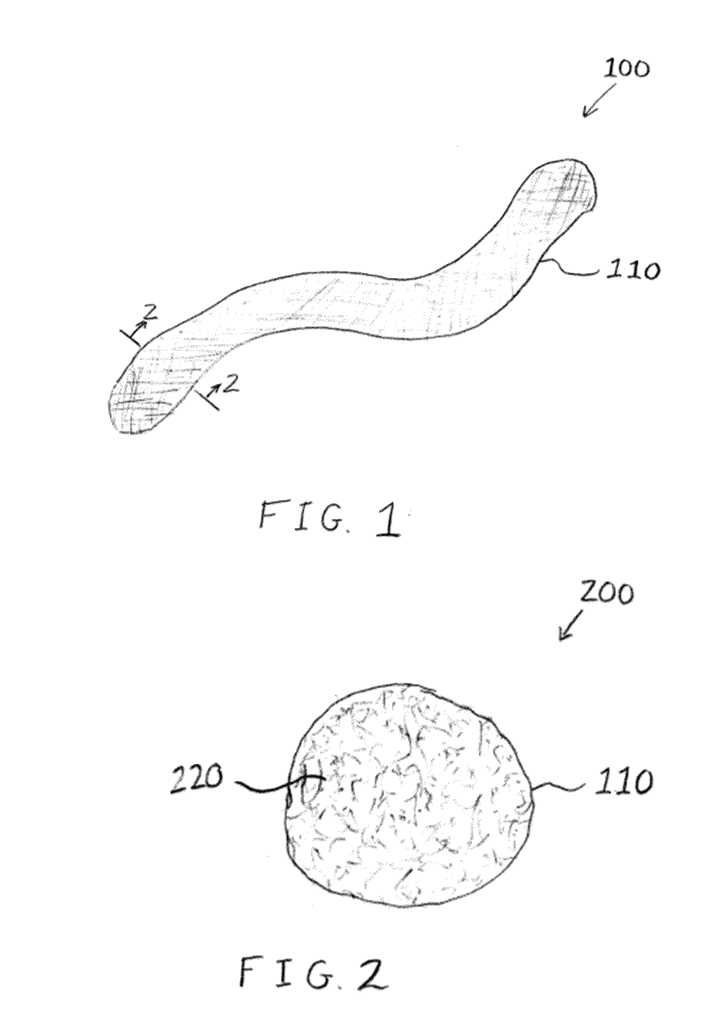

In one embodiment, the hydrocarbon absorbing apparatus comprises a containment device and an absorbent material. FIG. 1 is a perspective view of one embodiment of a hydrocarbon absorbing apparatus. Apparatus 100 includes a containment device 110. Enclosed within containment device 110 is an absorbent material (not shown). FIG. 2 is a cross-sectional view taken generally along line 2-2 of FIG. 1. Apparatus 200 includes absorbent material 220 enclosed within containment device 110.

The absorbent material may be comprised of shredded polyester fibers, shredded nylon fibers, or a combination thereof. In one embodiment, the shredded polyester fibers or shredded nylon fibers are obtained by shredding bulk nylon or polyester fibers or rope. In another embodiment, the shredded polyester or nylon fiber is obtained by shredding recycled nylon or polyester fibers or other recycled nylon or polyester materials. In yet another embodiment, the shredded polyester fibers or shredded nylon fibers are reinforcement cords reclaimed from used tires.

Reinforcement cords may be extracted from used tires by many methods. In one embodiment, the reinforcement cords may be extracted from used tires by shredding the tires and separating the tire components. The shredded reinforcement cord can be isolated from the other tire components. The shredded reinforcement cord should have a fluffy appearance and texture. In one embodiment, the shredded polyester or nylon fibers are less than or equal to about 0.5 inch in length. In another embodiment, the shredded fibers are between about 0.06 inch and about 0.4 inch in length. In yet another embodiment, the shredded fibers are between about 0.1 inch and 0.3 inch in length.

At least a portion of the containment device is comprised of a permeable material. In certain embodiments the entire containment device is comprised of permeable material. In other embodiments, at least 90% of the entire containment device is comprised of permeable material. In other embodiments, a lesser amount of the containment device is comprised of permeable material, such as 80%, 70%, 60%, or 50%. Permeable material includes materials permeable to hydrocarbons while still capable of containing all or substantially all of the absorbent material. The hydrocarbons may be any one or more of oil, crude oil, gasoline, diesel, and kerosene. In one embodiment, the containment device is comprised of material that is permeable to hydrocarbons, but is impervious to water or other liquids. In one embodiment, the permeable material of the containment device comprises at least one of a polymer (e.g., polyethylene or polypropylene) netting, a textile netting, a woven polymer, and a woven textile.

In another embodiment, the containment device includes different types of permeable materials in different sections of the apparatus. For example, a portion of the containment device that is located on the bottom side of the hydrocarbon absorbing apparatus may be comprised of a material that is more durable or more water resistant than the remainder of the containment device. Further, a portion of the containment device that is located on the bottom of the hydrocarbon absorbing apparatus may be comprised of a material that is impervious to hydrocarbons and other liquids.

At the point that absorbent material is placed within the containment device, the absorbent material and the containment device together form a hydrocarbon absorbing apparatus.

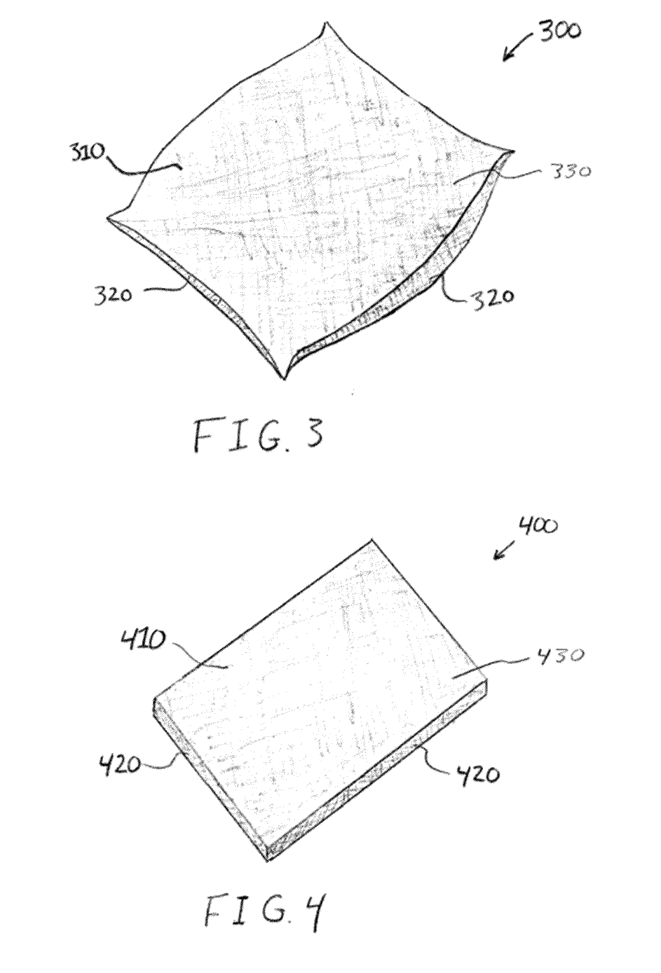

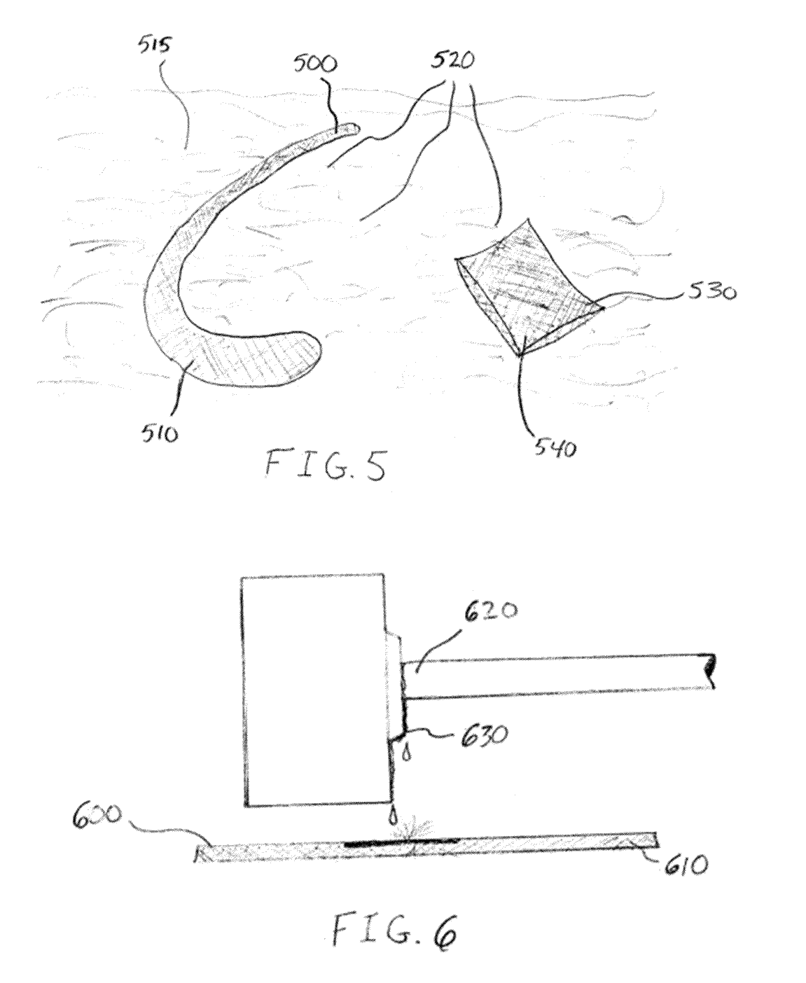

The containment device may be configured to form any of a variety of shapes and sizes such as a tube, a pillow, or a pad. FIG. 3 is a perspective view of one embodiment of a hydrocarbon absorbing apparatus, in which the containment device is configured to form a pillow. The apparatus 300 includes a containment device 310 having a plurality of side portions 320, a top portion 330, and a bottom portion (not shown). FIG. 4 is a perspective view of one embodiment of a hydrocarbon absorbing apparatus, in which the containment device is configured to form a pad. The apparatus 400 includes a containment device 410 having a plurality of side portions 420, a top portion 430, and a bottom portion (not shown). FIG. 5 is an illustration showing a method for using a hydrocarbon absorbing apparatus comprising a containment device 510 having an elongated tubular shape. The apparatus 500 includes a containment device 510, in which is enclosed an absorbent material. The apparatus 500 is exposed to the surface 515 of a volume of water, upon which hydrocarbons 520 are located.

In another embodiment, the containment device is configured such that a hydrocarbon absorbing apparatus may be linked to one or more additional hydrocarbon absorbing apparatuses, forming a chain, field, web, or network of hydrocarbon absorbing apparatuses. The containment device portion of the hydrocarbon absorbing apparatus may be configured to be connected to other containment devices via ties, ropes, chains, fasteners, stitching, and the like for connecting fabric devices to one another. In yet another embodiment, the containment device is divided into sections to create a plurality of cells within the hydrocarbon absorbing apparatus, each of which encloses absorbent material.

In other embodiments, one or more containment device portions of hydrocarbon absorbing apparatuses are connected (permanently or temporarily) to other items that may assist in holding the hydrocarbon absorbing apparatus(es) in a desired location to absorb hydrocarbon materials. Such other items may include items to help the hydrocarbon absorbing apparatus(es) avoid sinking, avoid blowing, or otherwise avoid moving out of the desired location. Useful items may include floats, buoys, weights, and anchors.

In one embodiment, the hydrocarbon absorbing apparatus can be used as a barrier device to prevent the spread of hydrocarbons from one side of the apparatus to the other. In another embodiment, the hydrocarbon apparatus may be towed along the surface of a body of water by one or more boats to form a U-shaped barrier, to collect hydrocarbons. In yet another embodiment, the hydrocarbon apparatus may be joined with one or more additional hydrocarbon absorbing apparatus(es) either end-to-end or side-by-side to create a barrier or collect hydrocarbons over a larger area of the water surface. The hydrocarbons that are absorbed may be one or more of oil, crude oil, gasoline, diesel, and kerosene.

In an exemplary embodiment, the hydrocarbon absorbing apparatus is buoyant and will float when placed upon the surface of water containing hydrocarbons. In this embodiment, the hydrocarbon absorbing apparatus is buoyant for a period of time at least equal to or greater than the period of time the apparatus absorbs hydrocarbons from the water surface. In another embodiment, the hydrocarbon absorbing apparatus is buoyant for the entire period of time that it is exposed to the water surface (i.e., until it is removed from the water surface). In one embodiment, the water surface may be of a natural body of water contaminated with a hydrocarbon, which may be crude oil. The hydrocarbon absorbing apparatus of the present invention remains buoyant even after absorbing many times its body weight of oil, without the aid of polystyrene chunks or other buoyancy aids.

In one embodiment a method for absorbing hydrocarbons is provided. The method includes the steps of placing an absorbent material in contact with a liquid surface containing hydrocarbons. The absorbent material is as described previously, and it absorbs a portion of the hydrocarbons on the liquid surface. With further reference to FIG. 5, a method is shown for using a hydrocarbon absorbing apparatus 530 having a pillow shape. The apparatus 530 includes a containment device 540 having an absorbent material enclosed therein. The apparatus 530 is exposed to surface 515 of a volume of water, upon which hydrocarbons 520 are located. In this embodiment, the containment device portion of the hydrocarbon absorbing apparatus is placed in contact with the liquid surface containing hydrocarbons. The hydrocarbons are absorbed through the permeable containment device by the absorbent material.

The portion absorbed may vary depending upon the amount of absorbent material utilized. In certain embodiments, 5%, 10%, 20%, 30%, 40%, 50%, 60%, 70%, 80%, 90%, or 100% of the hydrocarbons are absorbed by the absorbent material.

In another embodiment of the method for using the hydrocarbon absorbing apparatus, the apparatus comprises a containment device, and enclosed within the containment device is absorbent material. The hydrocarbon absorbing apparatus is placed within the vicinity to a hydrocarbon source. The proximity of the hydrocarbon absorbing apparatus to the hydrocarbon source may vary greatly depending upon the source. In some instances the hydrocarbon absorbing apparatus is within 6 inches or less of the hydrocarbon source and in other instances it is within 1 foot or less, 2 feet or less, 3 feet or less, 5 feet or less, or is more distantly located. In one embodiment, the containment device is configured to form the shape of a mat. In another embodiment, the hydrocarbon source is a piece of machinery. In such an embodiment, the apparatus is placed beneath the source to absorb hydrocarbons leaking from the source. For example, with reference to FIG. 6, the apparatus 600 comprises a containment device 610, enclosed within which is absorbent material. The apparatus 600 is placed within the vicinity to a hydrocarbon source 620 and exposed to hydrocarbons 630. In other embodiments, the hydrocarbon absorbing apparatus may be located more distant from the hydrocarbon source such as at the bottom of a hill.

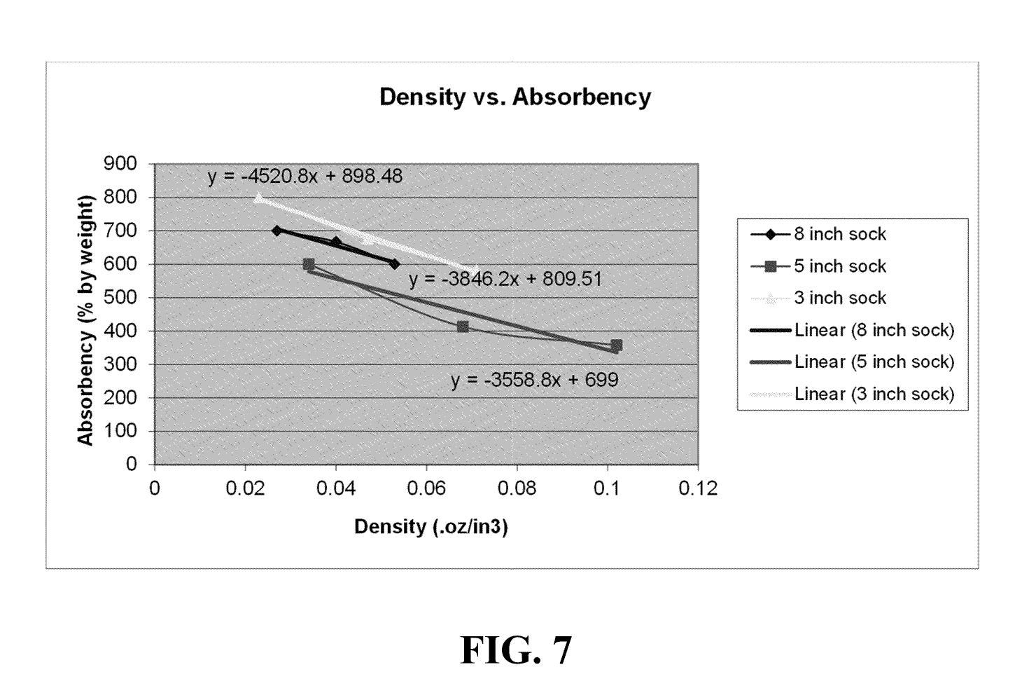

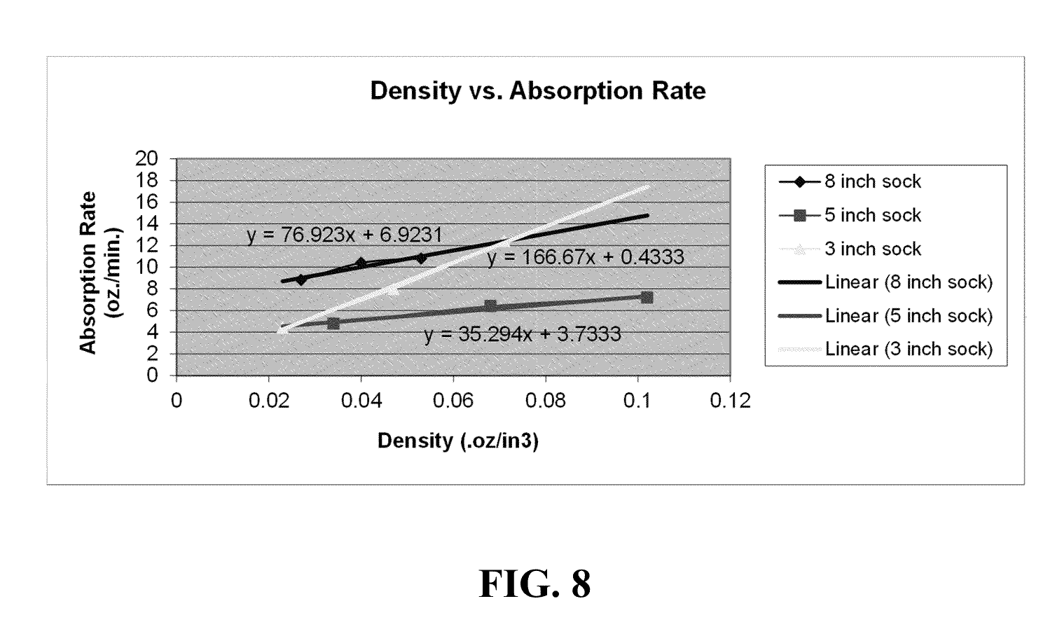

In one important aspect of the invention, the hydrocarbon absorbency properties of the hydrocarbon absorbing apparatus depend upon the amount of the absorbent material enclosed within the containment device per cubic inch of internal volume of the containment device. In one embodiment, the hydrocarbon absorbing apparatus contains from about 0.015 oz. to about 0.12 oz. of absorbent material per cubic inch of internal volume of the containment device. In another embodiment, the hydrocarbon absorbing apparatus contains from about 0.017 oz. to about 0.116 oz. of absorbent material per cubic inch of internal volume of the containment device. In yet another embodiment, the hydrocarbon absorbing apparatus contains from about 0.02 oz. to about 0.11 oz. of absorbent material per cubic inch of internal volume of the containment device. FIG. 7 shows example effects on absorbency of varying the amount of absorbent material within a containment device. FIG. 8 shows example effects on absorption rate of varying the amount of absorbent material within a containment device. The absorbent material used to generate the results in FIGS. 7 and 8 was tire cord from shredded scrap tires.

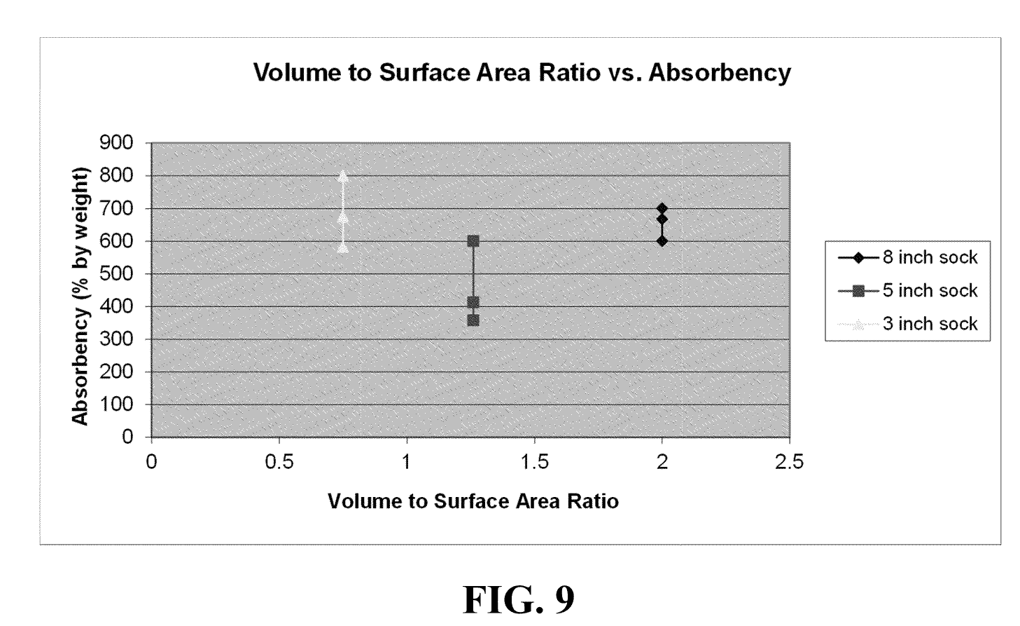

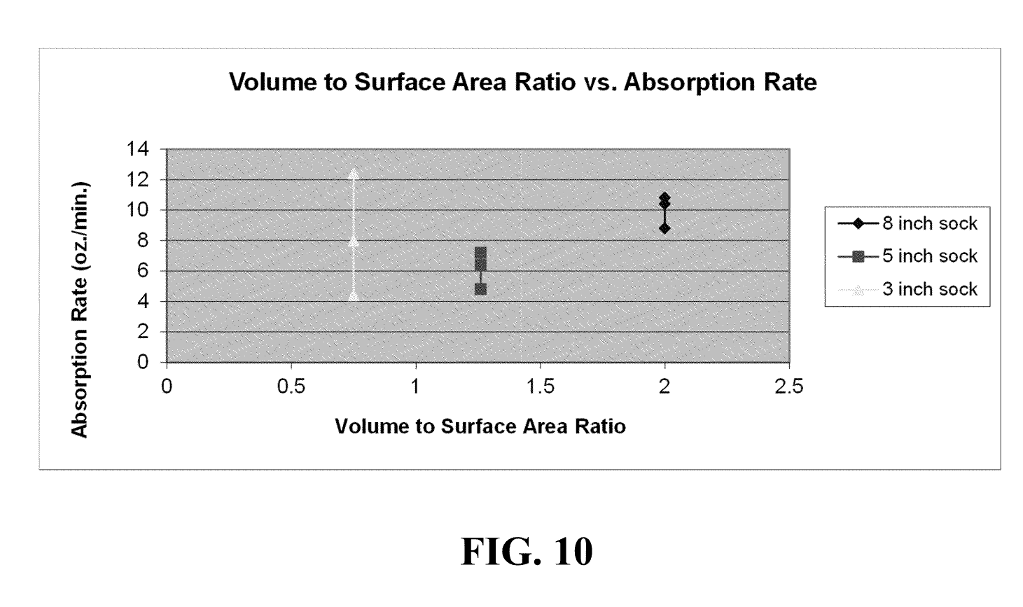

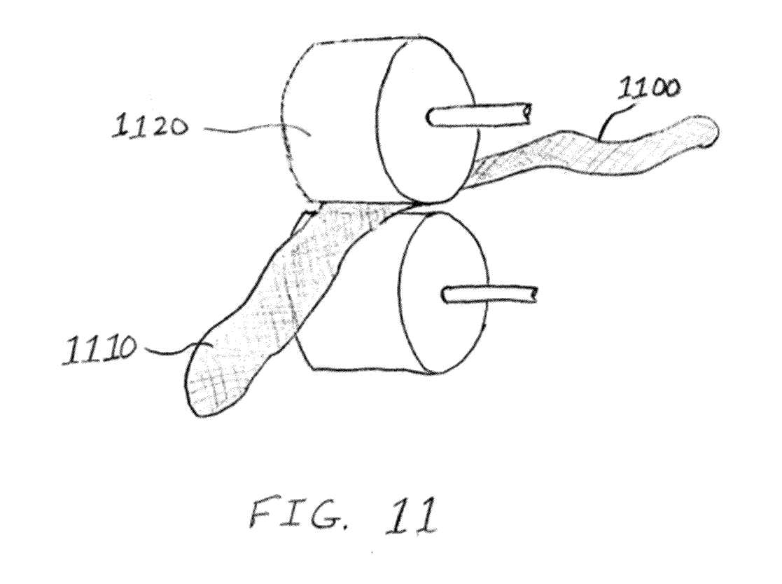

In another important aspect of the invention, the hydrocarbon absorbency properties of the hydrocarbon absorbing apparatus (including, but not limited to, the rate of absorption of the hydrocarbon material, the total amount of hydrocarbon material absorbed, and the amount of hydrocarbon material absorbed per weight of absorbent material) depend upon the ratio of volume to outer surface area of the containment device portion of the apparatus. In one embodiment, the containment device has a ratio of volume (in.³) to outer surface area (in.²) of about 0.50 to about 3 (that is, about 0.50 in.³/in.² to about 3 in.³/in.²). In another embodiment, the ratio is about 0.7 to about 2.05. In yet another embodiment, the ratio is about 0.75 to about 2. FIG. 9 shows example effects on absorbency of varying the ratio of volume to outer surface area of the containment device portion of the apparatus. FIG. 10 shows example effects on absorption rate of varying the ratio of volume to outer surface area of the containment device portion of the apparatus. The absorbent material used to generate the results in FIGS. 9 and 10 was tire cord from shredded scrap tires.

In another embodiment a method for absorbing hydrocarbons includes the additional step of removing the absorbent material from the first solid or liquid surface, compressing it to extract at least a portion of the absorbed hydrocarbons, and contacting the absorbent material to a second solid or liquid surface containing hydrocarbons. The first and second solid or liquid surfaces may be the same or different surfaces.

In another embodiment of a method for using the hydrocarbon absorbing apparatus, the apparatus comprises a containment device, and enclosed within the containment device is absorbent material, to form a hydrocarbon absorbing apparatus. The method includes the additional step of removing the hydrocarbon absorbing apparatus from contact with a first solid or liquid surface, compressing the apparatus with a compressing device to extract at least a portion of the hydrocarbons absorbed therein, so that the hydrocarbon absorbing apparatus can be contacted with a second solid or liquid surface containing hydrocarbons. In one embodiment, the first and second surfaces are the same surface. In another embodiment, the first and second surfaces are different surfaces. In yet another embodiment, the method for compressing the hydrocarbon absorbing apparatus and again contacting it with a surface containing hydrocarbons may be repeated one or more times until the apparatus no longer absorbs hydrocarbons, until all of the hydrocarbons have been absorbed, until a desired amount of hydrocarbons have been absorbed, or until a desired amount of time has passed.

Suitable compressing devices include any device that can be used to compress material. In one embodiment, the compressing device is a roller or a press. For example, FIG. 11 illustrates a device for compressing the hydrocarbon absorbing apparatus to extract at least a portion of the absorbed hydrocarbons. The apparatus 1100 comprises a containment device 1110, enclosed within which is an absorbent material. The method includes the additional step of removing apparatus 1100 from contact with the first solid or liquid surface, compressing apparatus 1100 with a compressing device 1120 to extract at least a portion of the hydrocarbons. After compression, apparatus 1100 can be again used to contact a second solid or liquid surface containing hydrocarbons. In another embodiment, the method utilizes a centrifuge to extract at least a portion of the hydrocarbons from the hydrocarbon absorbing apparatus.

The use of the term “includes” or “including” in the specification and the claims is intended to be inclusive in a manner similar to the term “comprising” as that term is interpreted when employed as a transitional word in a claim. Furthermore, where the term “or” is employed (e.g., A or B), it is intended to mean “A or B or both.” When the applicants intend to indicate “only A or B but not both” then the term “only A or B but not both” will be employed. Also, to the extent that the terms “in” or “into” are used in the specification or the claims, it is intended to additionally mean “on” or “onto,” and vice-versa.

While the present application has been illustrated by the description of particular embodiments, and while the embodiments have been described in considerable detail, it is not an intention to restrict or in any way limit the scope of the appended claims to such detail. With the benefit of the present application, additional advantages and modifications will readily appear to those skilled in the art. Therefore, the application, in its broader aspects, is not limited to the specific details and illustrative examples shown and described. Accordingly, departures may be made from such details without departing from the spirit or scope of the general inventive concept.

What is claimed is:

1. A hydrocarbon absorbing apparatus, comprising:
a containment device, at least a portion of which is comprised of a permeable material, wherein the containment device has a volume to outer surface area ratio of about 0.50 to 3; and
an absorbent material, comprised of at least one of polyester fibers and nylon fibers that have been shredded such that the apparatus floats when placed onto water,
wherein the absorbent material is enclosed within the containment device, and wherein the absorbent material is present within the containment device in a ratio of between about 0.015 to about 0.12 oz. of the absorbent material per cubic inch of the containment device, with the caveat that the apparatus does not include polystyrene.

2. The apparatus of claim 1, wherein the absorbent material is reinforcement cord from used tires.

3. The apparatus of claim 1, wherein the permeable material comprises at least one of a polymer netting, a textile netting, a woven polymer, and a woven textile.

4. The apparatus of claim 1, wherein the containment device is configured to form at least one of a tube, a pillow, and a pad.

5. The apparatus of claim 1, wherein the absorbent material is comprised of at least one of shredded polyester fibers and shredded nylon fibers having a length less than or equal to 0.5 inch.

6. The apparatus of claim 1, wherein the absorbent material is comprised of polyethylene terephthalate fibers.

7. The apparatus of claim 1, wherein the absorbent material is comprised of polyethylene terephthalate fibers coated with latex.

8. The apparatus of claim 2, wherein the absorbent material has been reclaimed by a process comprising shredding used tires comprising reinforcement cord.

9. A hydrocarbon absorbing apparatus, comprising:
a containment device, at least a portion of which is comprised of a permeable material; and
an absorbent material contained within the containment device in a ratio of between about 0.02 to about 0.11 oz. of the absorbent material per cubic inch of the containment device, the absorbent material being comprised of at least one of polyethylene terephthalate fibers and nylon fibers reclaimed from used tires, the fibers having been shredded such that the apparatus floats when placed onto water.

11. The apparatus of claim 9, wherein the permeable material comprises at least one of a polymer netting, a textile netting, a woven polymer, and a woven textile.

12. The apparatus of claim 9, wherein the absorbent material has been reclaimed by a process comprising the steps of: (1) shredding used tires comprising rubber, steel, and reinforcement cord, and (2) isolating the shredded reinforcement cord.

13. A method for absorbing hydrocarbons from a hydrocarbon-contaminated body of water, comprising placing an absorbent material contained within a water permeable containment device in contact with a surface of the body of water, wherein the absorbent material is reinforcement cord reclaimed from used tires, and is comprised of polyester fibers and/or nylon fibers that have been shredded such that the apparatus floats when placed upon the surface, the absorbent material being present within the containment device in a ratio of between about 0.015 to about 0.12 oz. of the absorbent material per cubic inch of the containment device and the containment device has a volume to outer surface area ratio of about 0.75 to about 2.

14. The method of claim 13, further comprising:
removing the absorbent material from contact with the surface;
compressing the absorbent material to extract at least of portion of any absorbed hydrocarbons; and
re-contacting the absorbent material with the surface.
